(19) United States
(12) Patent Application Publication
(10) Pub. No.: US 2018/0308114 A1
(43) Pub. Date: Oct. 25, 2018

(54) METHOD, DEVICE AND SYSTEM FOR EVALUATING PRODUCT RECOMMENDATION DEGREE

(71) Applicant: Guangdong Matview Intelligent Science & Technology Co., Ltd., Guangzhou (CN)

(72) Inventor: Libang Deng, Guangzhou (CN)

(21) Appl. No.: 15/709,461

(22) Filed: Sep. 19, 2017

(30) Foreign Application Priority Data
Apr. 24, 2017 (CN) 201710272374.2

(51) Int. Cl. G06Q 30/02; G06K 9/00

(52) U.S. Cl. CPC G06Q 30/0203; G06K 9/00302; G06K 9/00255

(57) ABSTRACT

The present invention discloses a method, device and system for evaluating a product recommendation degree. The method comprises the following steps: S1: establishing a facial recognition model base for humans; S2: acquiring facial recognition information about a human and a product viewing duration, the facial recognition information comprising a current feature vector of a human face; and S3: obtaining recommendation degree data for a user according to the facial recognition information and the product viewing duration. In the present invention, by acquiring through a camera video images of a user in the process of contacting a product, and analyzing a facial emotion change state of the user by an image recognition technique, in conjunction with the duration of the user viewing the product, recommendation degree data of the product are correspondingly formed, so that a product recommendation degree research can be performed efficiently.

### CROSS REFERENCE TO RELATED APPLICATIONS

The present application claims the benefit of Chinese Patent Application No. 201710272374.2 filed on Apr. 24, 2017. All the above are hereby incorporated by reference.

### TECHNICAL FIELD

The present invention relates to the technical field of image processing, and particularly to a method, device and system for evaluating a product recommendation degree.

### BACKGROUND

At present, related target user researches would be conducted before products are marketed; the existing product researches are mainly conducted by means of interviews or questionnaires, and a user' emotion and attitude for a product is judged according to a series of related questions answered by the user, so as to form a research report of the recommendation degree of the product. Since a large amount of valid samples are required for a research, and cooperation should be made with users to answer related questions validly, manpower, material resources and time costs that would be costed are all extremely high.

### SUMMARY OF INVENTION

To overcome the deficiencies of the prior art, the first objective of the present invention is to provide a method for evaluating a product recommendation degree, which is capable of solving the technical problem of recommending a product for a user.

The second objective of the present invention is to provide a device for evaluating a product recommendation degree, which is capable of solving the technical problem of recommending a product for a user.

The third objective of the present invention is to provide a system for evaluating a product recommendation degree, which is capable of solving the technical problem of recommending a product for a user.

The first objective of the present invention is implemented using the following technical solution:

A method for evaluating a product recommendation degree comprises the following steps:

S1: establishing a facial recognition model base for humans;

S2: acquiring facial recognition information about a human and a product viewing duration, the facial recognition information comprising a current feature vector of a human face; and

S3: obtaining recommendation degree data for a user according to a comparison result of the facial recognition information to the facial recognition model base and the product viewing duration.

Further, the step S1 particularly comprises the following sub-step:

S11: acquiring model recognition information upon a change in the user's emotion, the model recognition information comprising a model feature vector, and the model feature vector is a displacement change of a model feature point; and

S12: defining recommendation degree intervals as three intervals, i.e., recommended, calm and not recommended, and storing a corresponding set of model feature vectors in the different recommendation degree intervals, so as to form the facial recognition model base for humans.

Further, the number of the model feature points is a random numeric value between 70 and 75.

Further, the step S3 particularly comprises the following sub-step:

S301: comparing the acquired current feature vector to the set of model feature vectors in the facial recognition model base to obtain a comparison result;

S302: acquiring a product viewing duration for the corresponding product; and

S303: determining a belonging recommendation degree interval according to the comparison result and the product viewing duration, so as to obtain recommendation degree data for the user.

Further, the facial recognition information comprises a starting feature vector and an ending feature vector in a recognition process, and the step S3 particularly comprises the following sub-steps:

S31: obtaining a starting recommendation degree for the user according to the acquired starting feature vector;

S32: obtaining an ending recommendation degree for the user according to the acquired ending feature vector; and

S33: obtaining the recommendation data for the user in the recognition process according to a change between the ending recommendation degree and the starting recommendation degree.

The second objective of the present invention is implemented using the following technical solution:

A device for evaluating a product recommendation degree comprises the following modules:

a model establishment module for establishing an facial recognition model base for humans;

an information acquisition module for acquiring facial recognition information about a human and a product viewing duration, the facial recognition information comprising a current feature vector of a human face; and

a recommendation degree acquisition module for obtaining recommendation degree data for a user according to a comparison result of the facial recognition information to the facial recognition model base and the product viewing duration.

Further, the model establishment module particularly comprises the following sub-modules:

a model feature acquisition module for acquiring model recognition information upon a change in the user's emotion, the model recognition information comprising a model feature vector, and the model feature vector is a displacement change of model feature points; and

an interval division module for defining recommendation degree intervals as three intervals, i.e., recommended, calm and not recommended, and storing a corresponding set of model feature vectors in the different recommendation degree intervals, so as to form the facial recognition model base for humans.

Further, the recommendation degree acquisition module particularly comprises the following sub-modules:

a comparison result acquisition module for comparing the acquired current feature vector to the set of model feature vectors in the facial recognition model base to obtain a comparison result;

a time acquisition module for acquiring a product viewing duration for the corresponding product; and

a result judgement module for determining a belonging recommendation degree interval according to the comparison result, so as to obtain recommendation degree data for the user.

Further, the facial recognition information comprises a starting feature vector and an ending feature vector in a recognition process, and the recommendation degree acquisition module particularly comprises the following sub-modules:

a starting recommendation degree acquisition module for obtaining a starting recommendation degree for the user according to the acquired starting feature vector;

an ending recommendation degree acquisition module for obtaining an ending recommendation degree for the user according to the acquired ending feature vector; and

a recommendation degree calculation module for obtaining the recommendation data for the user in the recognition process according to a change between ending recommendation degree and the starting recommendation degree.

The third objective of the present invention is implemented using the following technical solution:

A system for evaluating a product recommendation degree comprises an executor, wherein the executor is used for executing the method for evaluating a product recommendation degree as described in any one of the above.

Compared to the prior art, the beneficial effects of the present invention are as follows:

In the present invention, by acquiring through a camera video images of a user in the process of contacting a product, and analyzing a facial emotion change state of the user by an image recognition technique, in conjunction with the duration of the user viewing the product, recommendation degree data of the product are correspondingly formed, so that a product recommendation degree research can be performed efficiently, thereby saving time and labor cost and improving the accuracy of research data. At the same time, the system can be applied to the link of product marketing and recommendation, realizing precise marketing for target users.

### BRIEF DESCRIPTION OF THE DRAWINGS

FIG. 1 is a flowchart of a method for evaluating a product recommendation degree of the present invention; and

FIG. 2 is a structural diagram of a device for evaluating a product recommendation degree of the present invention.

### DETAILED DESCRIPTION

Hereinafter, further description is made to the present invention in combination with the accompany drawings and the detailed description. It should be noted that various embodiments or various technical features described below can be arbitrarily combined to form new embodiments without conflict.

The present invention primarily comprises a camera and a recognition module. The camera: facial video images during a user viewing each product are acquired through the camera. The recognition module comprises a recognition model and recommendation degree recognition. The video images of the user's behavior of viewing the product, which are acquired by the camera, are analyzed by utilizing the established recognition model; and a recommendation degree of the product is calculated in comparison to the recognition model according to the user's continuous facial emotion changes and stay time upon viewing each product. Recognition model: by extracting a key frame from the facial video images and constructing facial key points, features of the key points are extracted; by learning the video of a large amount of users during viewing a product, a training set template base corresponding to each recommendation degree interval is established, as a recommendation degree recognition model, according to facial expression and emotion change information and product viewing time information.

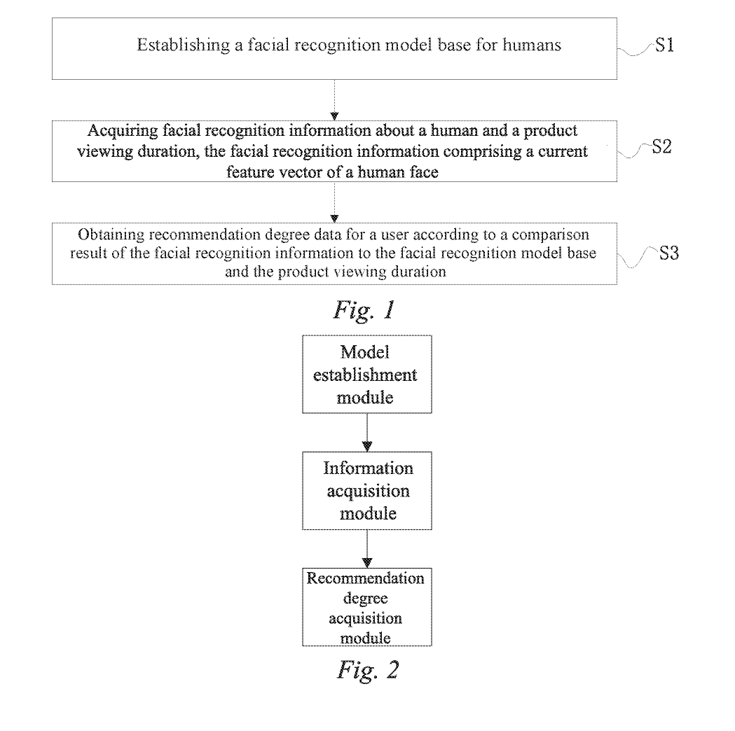

As shown in FIG. 1, the present invention provides a method for evaluating a product recommendation degree, comprising the following steps:

S1: a facial recognition model base for humans is established. The step Si particularly comprises the following sub-step:

S11: acquiring model recognition information upon a change in the user's emotion, the model recognition information comprising a model feature vector, and the model feature vector is a displacement change of a model feature point; and the number of the model feature points is a random numeric value between 70 and 75.In this embodiment, 72 key points are adopted to describe facial features, and the facial structure and the morphologic combination of five sense organs of a human have significant characteristics during emotion changes. Through learning and continuous correction, 72 key points that can reflect facial emotion changes of the human and are stable when various angles of the human face are shifted under the influence of various ray-casting external environments are found according to facial organs such as eyebrows, eyes, canthus, nose, nostril, lips and cheekbones and the structural and profile combination characteristics of the various components; and a recognition model base is established based on the 72 key points.

S12: recommendation degree intervals are defined as three intervals, i.e., recommended, calm and not recommended, and storing a corresponding set of model feature vectors in the different recommendation degree intervals, so as to form the facial recognition model base for humans. The recognition model is established with an overall recommendation degree percentage in correspondence to each recommendation degree interval. A lower numeric value indicates a lower recommendation degree, and a higher numeric value indicates a higher recommendation degree; namely, 0-35 indicates not recommended, 35-65 indicates calm, and 65-100 indicates recommended. A numeric value approximating 0 indicates completely not interested, even dislike and not suggested to recommend, and a numeric value approximating 100 indicates very interested and highly recommended. By training through machine learning and by analyzing facial video of a large amount of service objects, statistics is made about point coordinate data of the 72 characteristic points upon different emotion changes, and a coordinate offset thereof under different emotions is calculated, so as to form a feature vector for describing facial emotion changes; the feature vector is stored in correspondence to a template base of the interval of recommended, calm and not recommended, so as to establish a recommendation degree recognition model; and in the process of training, the recommendation degree interval corresponding to the feature vector needs to be specified, and the set of feature vectors of each interval is trimmed by continuously comparing a recognition result of the model.

S2: acquiring facial recognition information about a human and a product viewing duration, the facial recognition information comprising a current feature vector of a human face; and the product viewing duration provides a dimension of judgement for the user, which means that when recognition and judgement are performed on the user, not only information about facial emotions needs to be considered, the corresponding duration also needs to be considered. Even if the expression of the user indicates very satisfied, when the user's viewing duration is less than one second, it indicates that the user is not interested in the product.

S3: obtaining recommendation degree data for a user according to a comparison result of the facial recognition information to the facial recognition model base and the product viewing duration. In particular implementations, there may be two different ways to determine a user's emotion state. The first way is to directly determine the user's emotion state, and the step S3 particularly comprises the following sub-steps:

S301: comparing the acquired current feature vector to the set of model feature vectors in the facial recognition model base to obtain a comparison result; a model feature vector most close to the current feature vector is determined according to a similarity, and the obtained model feature vector is mapped to each recommendation degree interval; and then a recommendation degree percentage is obtained to determine the recommendation degree.

S302: a product viewing duration for the corresponding product is acquired, and the duration of the user viewing and contacting different products in the video is correspondingly extracted, so as to calculate viewing duration data. This step is used to judge whether a user likes a product from the time dimension; the time can be a fixed numeric value, which indicates that the user is interested in the product when greater than a pre-set time, and indicates that the user is not interested in the product when smaller than the pre-set time; alternatively, a time range can be set, such as 5 s to 10 s, the time being smaller than the minimum value in the time range indicates that the user is not interested, and the time being within the interval indicates that the user is relatively interested, and the time being greater than the maximum value in the time range indicates that the user is very interested.

S303: determining a belonging recommendation degree interval according to the comparison result and the product viewing duration, so as to obtain recommendation degree data for the user. The recommendation degree data is whether the user's current state is recommended, calm or not recommended; in this way, how the user likes a product at present can be shown in real time.

However, since one's emotion continuously changes with time, and in the entire service process, one's emotion may also change due to the attitude of related personnel, we cannot make a corresponding judgement by singly considering a user's current motion, but make the corresponding judgement in conjunction with the user's emotion in the entire service process. The facial recognition information comprises a starting feature vector and an ending feature vector in a recognition process, and the step S3 particularly comprises the following sub-steps:

S31: obtaining a starting recommendation degree for the user according to the acquired starting feature vector;

S32: obtaining an ending recommendation degree for the user according to the acquired ending feature vector; and

S33: obtaining the recommendation data for the user in the recognition process according to a change between the ending recommendation degree and the starting recommendation degree. Taking a recommendation degree recognition result at the preliminary stage of the service as a basis for recognizing initial data, the recommendation degree data for the user in the entire service process is determined based on the initial data and the recommendation degree change data for the user in the service process.

The recommendation degree recognition result of the present invention can also be applied in the process of product marketing, and assists the sales personnel in judging whether a user is a target user of the product; and after the recognition, statistical analysis can be made to the recognized recommendation degree result data, and a visual analysis report is formed from the data. The account of each personnel corresponds to respective statistical recommendation degree result data which is stored in correspondence to user accounts; and statistical analysis will also be made to the overall service recommendation degree in each time period. An administrator logs in and checks statistical recommendation degree result data of each personnel and an overall recommendation degree analysis report through a data management background, bringing more convenience for later management.

The working principle of the present invention is as follows:

In product recommendation degree researches, during a user contacting and viewing each product, the user's facial video images are acquired through a camera configured in a mobile phone or a computer or through a camera configured in front of different products in a product exhibition hall; and

a recognition module of a server acquires the user's facial video images captured by the camera, extracts a feature vector of the user's facial emotion and expression change during viewing and contacting each product, calculates a viewing duration, compares the above-mentioned data information to a recognition model and calculates a recommendation degree result of each product corresponding to the user. By means of the recommendation degree result information of massive users, according to the statistical user gender, age and job information, a target user group analysis report for a positioned product is formed.

Therefore, the product of the present invention can not only be applied in the scenario where recommendation is made for a user via an electronic product, wherein a user's state is acquired through a camera on the electronic product, so as to obtain recommendation degree data, but judgement can also be made about the user's emotional reaction in conjunction with the service of related sales personnel; therefore, the objectivity and authenticity of data are ensured, product recommendation degree researches can be made more efficiently.

As shown in FIG. 2, the present invention provides a device for evaluating a product recommendation degree, comprising the following modules:

a model establishment module for establishing an facial recognition model base for humans; wherein the model establishment module particularly comprises the following sub-modules:

a model feature acquisition module for acquiring model recognition information upon a change in the user's emotion, the model recognition information comprising a model feature vector, and the model feature vector is a displacement change of model feature points; and

an interval division module for defining recommendation degree intervals as three intervals, i.e., recommended, calm and not recommended, and storing a corresponding set of model feature vectors in the different recommendation degree intervals, so as to form the facial recognition model base for humans, wherein the number of the model feature points is a random numeric value between 70 and 75;

an information acquisition module for acquiring facial recognition information about a human and a product viewing duration, the facial recognition information comprising a current feature vector of a human face; and

a recommendation degree acquisition module for obtaining recommendation degree data for a user according to the facial recognition information and the product viewing duration. There are two different implementations for the process of recommendation degree acquisition. The first implementation is that the recommendation degree acquisition module particularly comprises the following sub-modules:

a comparison result acquisition module for comparing the acquired current feature vector to the set of model feature vectors in the facial recognition model base to obtain a comparison result;

a time acquisition module for acquiring a product viewing duration for the corresponding product; and

a result judgement module for determining a belonging recommendation degree interval according to the comparison result, so as to obtain recommendation degree data for the user.

The second implementation is that the facial recognition information comprises a starting feature vector and an ending feature vector in a recognition process, and that the recommendation degree acquisition module particularly comprises the following sub-modules:

a starting recommendation degree acquisition module for obtaining a starting recommendation degree for the user according to the acquired starting feature vector;

an ending recommendation degree acquisition module for obtaining an ending recommendation degree for the user according to the acquired ending feature vector; and

a recommendation degree calculation module for obtaining the recommendation data for the user in the recognition process according to a change between ending recommendation degree and the starting recommendation degree.

Above-mentioned embodiments only are preferred embodiments of the present invention, they cannot limit the scope of protection of the present invention, furthermore, all the non-substantial modifications and substitutions made by a person skilled in the art based on the present invention belong the scope of protection of the present invention.

What is claimed is:

1. A method for evaluating a product recommendation degree, comprising the following steps:
S1: establishing a facial recognition model base for humans;
S2: acquiring facial recognition information about a human and a product viewing duration, the facial recognition information comprising a current feature vector of a human face; and
S3: obtaining recommendation degree data for a user according to a comparison result of the facial recognition information to the facial recognition model base and the product viewing duration.

2. The method for evaluating a product recommendation degree of claim 1, wherein the step S1 particularly comprises the following sub-steps:
S11: acquiring model recognition information upon a change in the user's emotion, the model recognition information comprising a model feature vector, and the model feature vector is a displacement change of a model feature point; and
S12: defining recommendation degree intervals as three intervals, i.e., recommended, calm and not recommended, and storing a corresponding set of model feature vectors in the different recommendation degree intervals, so as to form the facial recognition model base for humans.

3. The method for evaluating a product recommendation degree of claim 2, wherein the number of the model feature point is a random numeric value between 70 and 75.

4. The method for evaluating a product recommendation degree of claim 2, wherein the step S3 particularly comprises the following sub-steps:
S301: comparing the acquired current feature vector to the set of model feature vectors in the facial recognition model base to obtain a comparison result;
S302: acquiring a product viewing duration for the corresponding product; and
S303: determining a belonging recommendation degree interval according to the comparison result and the product viewing duration, so as to obtain recommendation degree data for the user.

5. The method for evaluating a product recommendation degree of claim 2, wherein the facial recognition information comprises a starting feature vector and an ending feature vector in a recognition process, and the step S3 particularly comprises the following sub-steps:
S31: obtaining a starting recommendation degree for the user according to the acquired starting feature vector;
S32: obtaining an ending recommendation degree for the user according to the acquired ending feature vector; and
S33: obtaining the recommendation data for the user in the recognition process according to a change between the ending recommendation degree and the starting recommendation degree.

6. A device for evaluating a product recommendation degree, comprising the following modules:
a model establishment module for establishing an facial recognition model base for humans;
an information acquisition module for acquiring facial recognition information about a human and a product viewing duration, the facial recognition information comprising a current feature vector of a human face; and
a recommendation degree acquisition module for obtaining recommendation degree data for a user according to a comparison result of the facial recognition information to the facial recognition model base and the product viewing duration.

7. The device for evaluating a product recommendation degree of claim 6, wherein the model establishment module particularly comprises the following sub-modules:
a model feature acquisition module for acquiring model recognition information upon a change in the user's emotion, the model recognition information comprising a model feature vector, and the model feature vector is a displacement change of model feature points; and
an interval division module for defining recommendation degree intervals as three intervals, i.e., recommended, calm and not recommended, and storing a corresponding set of model feature vectors in the different recommendation degree intervals, so as to form the facial recognition model base for humans.

8. The device for evaluating a product recommendation degree of claim 7, wherein the recommendation degree acquisition module particularly comprises the following sub-modules:
a comparison result acquisition module for comparing the acquired current feature vector to the set of model feature vectors in the facial recognition model base to obtain a comparison result;
a time acquisition module for acquiring a product viewing duration for the corresponding product; and
a result judgement module for determining a belonging recommendation degree interval according to the comparison result, so as to obtain recommendation degree data for the user.

9. The device for evaluating a product recommendation degree of claim 7, wherein the facial recognition information comprises a starting feature vector and an ending feature vector in a recognition process, and the recommendation degree acquisition module particularly comprises the following sub-modules:
a starting recommendation degree acquisition module for obtaining a starting recommendation degree for the user according to the acquired starting feature vector;
an ending recommendation degree acquisition module for obtaining an ending recommendation degree for the user according to the acquired ending feature vector; and
a recommendation degree calculation module for obtaining the recommendation data for the user in the recognition process according to a change between ending recommendation degree and the starting recommendation degree.

10. A system for evaluating a product recommendation degree, comprising an executor, wherein the executor is used for executing the method for evaluating a product recommendation degree of claim 1.
